(19) United States
(12) Patent Application Publication
(10) Pub. No.: US 2017/0324077 A1
(43) Pub. Date: Nov. 9, 2017

(54) PLASMA BATTERY ELECTRODE COATING ON CURRENT COLLECTOR PRETREATED WITH CONDUCIVE MATERIAL

(71) Applicant: GM GLOBAL TECHNOLOGY OPERATIONS LLC, DETROIT, MI (US)

(72) Inventors: Jianyong Liu, Shanghai (CN); Su Xiang Deng, Shanghai (CN); Xiaohong Q. Gayden, West Bloomfield, MI (US)

(21) Appl. No.: 15/527,398

(22) PCT Filed: Dec. 4, 2014
(86) PCT No.: PCT/CN2014/093027

§ 371 Date: May 17, 2017

(51) Int. Cl. H01M 4/04; H01M 4/66; H01M 4/62; H01M 4/587; H01M 4/485; H01M 4/1393; H01M 10/0525; H01M 4/1391

(52) U.S. Cl. CPC H01M 4/0423; H01M 10/0525; H01M 4/661; H01M 4/625; H01M 4/1391; H01M 4/587; H01M 4/485; H01M 4/1393; H01M 4/623

(57) ABSTRACT

Particles of active electrode material for a lithium-ion cell are suspended in an atmospheric plasma-activated gas stream and deposited on a surface of a metal current collector foil having a surface film of an oxide of the metal. The metal oxide film-containing surface of the current collector is pre-coated with a thin layer of an electrically conductive organic polymer composition that serves as a bonding surface for the plasma-applied particles of electrode material. For example, a non-conductive polymer (such as polyvinylidene difluoride) may be filled with carbon particles or copper particles. The polymer layer is typically only a few micrometers in thickness and composed to be compatible with the plasma-applied electrode material particles and to conduct electrons between the oxide film-coated, metal current collector and the deposited electrode layer.

### TECHNICAL FIELD

This invention pertains to the use of an atmospheric plasma spray device to apply a layer of particulate electrode material to a surface of a metal current collector foil in the manufacture of a positive or negative electrode member for a lithium-ion cell or battery. The surface of the metal current collector foil, having an inherent metal oxide surface film, is prepared to receive and bond with the plasma-activated electrode particles despite the metal oxide barrier.

### BACKGROUND OF THE INVENTION

Assemblies of lithium-ion and other lithium ion transporting battery cells are finding increasing applications in providing electric power in automotive vehicles and in many non-automotive applications.

Each lithium-ion cell of the battery is capable of providing an electrical potential of about three to four volts and a direct electrical current, based on the composition and mass of the electrode materials in the cell. The cell is capable of being discharged and re-charged over many cycles. A battery is assembled for an application by combining a suitable number of individual cells in a combination of electrical parallel and series connections to satisfy voltage and current requirements for a specified electric motor. In a lithium-ion battery application for an electrically powered vehicle, the assembled battery may, for example, comprise up to three hundred individually packaged cells that are electrically interconnected to provide forty to four hundred volts and sufficient electrical power to an electrical traction motor to drive a vehicle. The direct current produced by the battery may be converted into an alternating current for more efficient motor operation.

In these automotive applications, each lithium-ion cell typically comprises a negative electrode layer (anode, during cell discharge), a positive electrode layer (cathode, during cell discharge), a thin porous separator layer interposed in face-to-face contact between parallel, facing, electrode layers, and a liquid, lithium-containing, electrolyte solution filling the pores of the separator and contacting the facing surfaces of the electrode layers for transport of lithium ions during repeated cell discharging and re-charging cycles. Each electrode is prepared to contain a layer of an electrode material, typically deposited as a wet mixture on a thin layer of a metallic current collector.

For example, the negative electrode material has been formed by spreading a thin layer of graphite particles, or of lithium titanate particles, and a suitable polymeric binder onto one or both sides of a thin foil of copper which serves as the current collector for the negative electrode. The positive electrode also comprises a thin layer of resin-bonded, porous, particulate lithium-metal-oxide composition spread on and bonded to a thin foil of aluminum which serves as the current collector for the positive electrode. Thus, the respective electrodes have been made by dispersing mixtures of the respective binders and active particulate materials in a suitable liquid, depositing the wet mixture as a layer of controlled thickness on the surface of a current collector foil, and drying, pressing, and fixing the resin-bonded electrode particles to their respective current collector surfaces. The positive and negative electrodes may be formed on conductive metal current collector sheets of a suitable area and shape, and cut (if necessary), folded, rolled, or otherwise shaped for assembly into lithium-ion cell containers with suitable porous separators and a liquid electrolyte.

There remains a need for more efficient and economic methods for the making of the respective electrode members of lithium batteries.

### SUMMARY OF THE INVENTION

In many lithium-ion cell designs, a layer of a selected electrode material is deposited on the surface of a sheet or foil of a highly electrically conductive metal such as substantially pure copper or aluminum, or of high electrical conductivity alloys of these metals. In practices of this invention it is desired to suspend particles of electrode material in a stream of air (or other suitable carrier gas), pass the gas stream through a plasma generator to heat the particles in the gas stream, and then to direct the gas-borne, plasma-heated, electrode material particles against the surface of the current collector to deposit and form a uniform layer of the electrode particles on the surface. The electrode material particles may be coated with or mixed with particles of a binder. Or a binder material may be separately deposited with or onto the electrode particles using a separate binder particle delivery device. But the atmospheric plasma deposition process is conducted to form a porous layer of electrode material on a surface of the current collector in which the particles are, at some specified stage of the process, suitably bonded to each other and to the current collector surface.

In many lithium battery electrode designs, the metal current collector foil is, for example, rectangular in shape with specified side dimensions depending on the desired sectional configuration of the cell unit. In many cell designs the thickness of the current collector foil or sheet is in the range of about eight to twelve micrometers and the thickness of the applied electrode material is about twenty to two hundred micrometers. The current collector foil may have a connector tab extending from one of its sides so that it can be connected to other electrode members in the assembly of a cell unit or module of cell units. The particulate electrode material is bonded to one or both sides of the current collector, except for the connector tab.

In a lithium battery manufacturing process many electrode members may be produced in a manufacturing line in which electrode material particles are progressively deposited on surfaces of current collector material. Sometimes the current collector metal surface has a thin layer of the respective metal oxide. For example, the surfaces of copper current collector material may carry a film of copper oxide, and surfaces of aluminum material, a film of an oxide of aluminum. It is found that such oxide films, even though quite thin, can interfere with the bonding of plasma-spray applied, electrode material particles to the current collector surface. Poor bonding of the electrode material also inhibits necessary electrical conductivity between the electrode material and its current collector.

In accordance with plasma deposition practices of this invention, we use current collector metal foils in which their surface(s) are pre-coated with a uniformly thick layer (suitably about one to three micrometers in thickness) of a conductive, carbon-base polymer material. In a first example, a non-conductive polymer, filled with submicron-size conductive carbon or metal particles, is used as the adherent conductive coating over the metal oxide surface of the current collector. In another example, a non-conductive polymer binder may be filled with powder particles of a conductive polymer composition. And in another example, a conductive polymer composition, or conductive co-polymer composition, may be used alone as the conductive coating layer on the metal oxide film. In many applications, a thin layer of a suitable non-conductive polymer, filled with a suitable quantity of conductive carbon or metal particles, serves to bond to and isolate the metal oxide surface from the plasma deposited electrode material particles and to serve as adherent surface for the electrode particles. The electrically conductive polymer coating is to be free of defects, such as pinholes, that expose the metal oxide film.

For example, a suitable coating material may comprise a predetermined proportion of nanometer (sub-micron) size, conductive carbon particles dispersed in a layer of polyvinylidene difluoride. Conductive carbon particles include graphite particles and suitable amorphous carbon particles. It is found that the exposed surface of the carbon-filled polymer layer is receptive to bonding with the plasma-applied electrode material particles, and the thin body of the conductive polymer layer provides an electron conductive path between the layer of electrode particles and their current collector layer. Other combinations of conductive particles and a polymer matrix may be used providing they are suitably electrically conductive and the deposited electrode particles readily bond to the polymer surface. While conductive carbon particles may be preferred, copper particles or aluminum particles may be dispersed in the polymer matrix.

The conductive polymer layer may be pre-formed on the current collector metal foil as it is being prepared and shipped to a manufacturing site for deposition of the particulate electrode material. In this embodiment, the polymer coating may be applied to a relatively large metal sheet from which individual current collector members are cut. Or the conductive polymer coating may be applied to current collector member surfaces just prior to plasma-activated deposition of the particulate electrode material.

Other objects and advantages of the invention will be apparent from the following descriptions of illustrative examples of practices of the invention.

### BRIEF DESCRIPTION OF THE DRAWINGS

FIG. 1 is an enlarged schematic illustration of the anode, separator, and cathode elements for a representative lithium-ion cell. The anode and cathode each consist of a metal current collector with a porous bonded layer of particulate electrode material. In accordance with practices of this invention a metal oxide-bearing surface of the metal current collector is coated with a suitable electrically conductive polymer layer that enables the adherence of plasma-activated electrode material particles to the micrometer thick, conductive polymer layer despite the presence of a metal oxide film on the current collector surface.

FIGS. 2A-2C are enlarged schematic illustrations of cross-sectional views of a portion of a copper current collector foil with a copper oxide film on its upper surface which is intended to receive a layer of electrode material particles. FIG. 2A illustrates the copper oxide film on the surface of the copper current collector foil. FIG. 2B illustrates a conductive polymer coating applied over the copper oxide film, and FIG. 2C illustrates the first two layers of electrode material particles which have been applied from an atmospheric plasma spray device to the conductive polymer-coated surface of the current collector.

FIG. 3 is a schematic illustration of an atmospheric plasma spray device for depositing particles of, for example, a negative electrode material, such as particles of lithium titanate, on a conductive particle-filled polymer-coated surface of a current collector foil.

### DESCRIPTION OF PREFERRED EMBODIMENTS

An illustrative lithium-ion cell will be described, in which an electrode member can be prepared using practices of this invention.

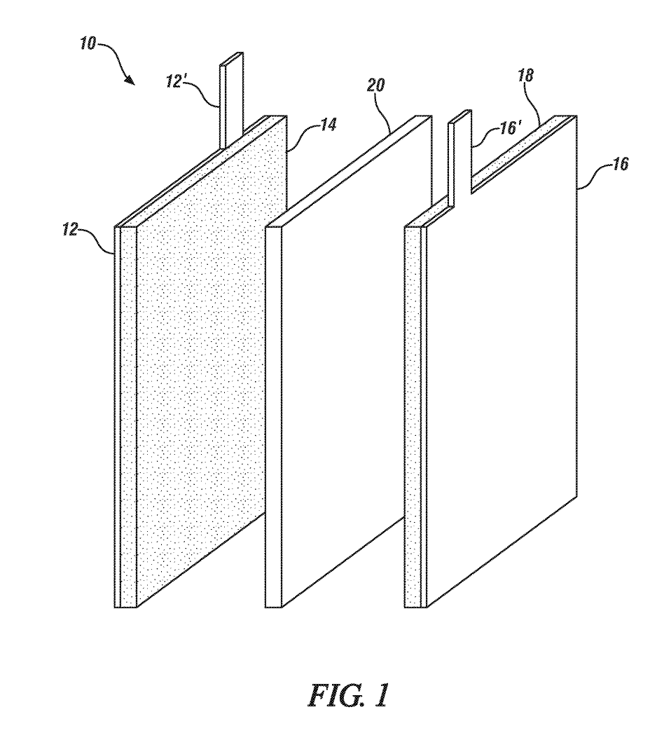

FIG. 1 is an enlarged schematic illustration of a spaced-apart assembly 10 of three solid members of a lithium-ion electrochemical cell. The three solid members are spaced apart in this illustration to better show their structure. The illustration does not include an electrolyte solution whose composition and function will be described in more detail below in this specification. Practices of this invention are typically used to manufacture electrode members of the lithium-ion cell when they are used in the form of relatively thin, layered structures.

In FIG. 1, a negative electrode comprises a relatively thin conductive metal foil current collector 12. In many lithium-ion cells, the negative electrode current collector 12 is suitably formed of a thin layer of copper or stainless steel. The thickness of the metal foil current collector is suitably in the range of about five to twenty-five micrometers. The current collector 12 has a desired two-dimensional plan-view shape for co-deposition or assembly with other solid members of a cell. Current collector 12 is illustrated as rectangular over its principal surface, and further provided with a connector tab 12′ for connection with other electrodes in a grouping of lithium-ion cells to provide a desired electrical potential or electrical current flow.

Deposited on the negative electrode current collector 12 is a thin, porous layer of negative electrode material 14. As illustrated in FIG. 1, the layer of negative electrode material 14 is typically co-extensive in shape and area with the main surface of its current collector 12. The electrode material has sufficient porosity to be infiltrated by a liquid, lithium-ion containing electrolyte. The thickness of the rectangular layer of negative electrode material may be up to about two hundred micrometers so as to provide a desired current and power capacity for the negative electrode. As will be further described, the negative electrode material may be applied layer-by-layer (e.g., by atmospheric plasma deposition) so that one large face of the final block layer of negative electrode material 14 is bonded to a major face of current collector 12 and the other large face of the negative electrode material layer 14 faces outwardly from its current collector 12.

A positive electrode is shown, comprising a positive current collector foil 16 (often formed of aluminum or stainless steel) and a coextensive, overlying, porous deposit of positive electrode material 18. Positive current collector foil 16 also has a connector tab 16′ for electrical connection with other electrodes in other cells that may be packaged together in the assembly of a lithium-ion battery. The positive current collector foil 16 and its coating of porous positive electrode material 18 are typically formed in a size and shape that are complementary to the dimensions of an associated negative electrode. In the illustration of FIG. 1, the two electrodes are alike in their shapes (but they do not have to be identical), and assembled in a lithium-ion cell with the major outer surface of the negative electrode material 14 facing the major outer surface of the positive electrode material 18. The thicknesses of the rectangular positive current collector foil 16 and the rectangular layer of positive electrode material 18 are typically determined to complement the negative electrode material 14 in producing the intended electrochemical capacity of the lithium-ion cell. The thicknesses of current collector foils are typically in the range of about 5 to 25 micrometers. And the thicknesses of the electrode materials, formed by this dry atmospheric plasma process are up to about 200 micrometers. Again, in accordance with practices of this invention, the positive electrode material (or cathode during cell discharge) is formed by an atmospheric plasma deposition method, using one or more atmospheric plasma spray devices, to deposit activated particles of cathode material on a metallic current collector foil substrate.

As stated above in this specification, either the metal negative electrode current collector or the metal positive electrode current collector may have a very thin metal oxide film on its surface that could adversely affect the atmospheric plasma deposition of the corresponding particulate electrode material. Such a metal oxide film on a metal current collector is not illustrated in the generalized illustration of FIG. 1. However, as described and illustrated in more detail below in this specification, this invention provides practices for covering the metal oxide film with a thin layer of a conductive particle-filled polymer mixture that is receptive to the plasma deposit of particulate electrode material and that is free of pin-holes and like defects exposing the metal oxide surface.

A thin porous separator layer 20 is interposed between the major outer face of the negative electrode material layer 14 and the major outer face of the positive electrode material layer 18. The porous separator may be formed of a porous film or of interwoven fibers of suitable polymer material, or of ceramic particles, or a polymer material filled with ceramic particles. The porous separator layer is filled with a liquid lithium-ion containing electrolyte and enables the transport of lithium ions between the porous electrode members. But the separator layer 20 is used to prevent direct electrical contact between the negative and positive electrode material layers 14, 18, and is shaped and sized to serve this function.

In prior practices of making the elements of a lithium-ion cell the electrode structures and the separators were formed separately and then combined in the assembly of the cell. In such practices, the opposing major outer faces of the electrode material layers 14, 18 are pressed against the major area faces of the separator membrane 20. A liquid electrolyte is injected into the pores of the separator membrane 20 and electrode material layers 14, 18. In preferred practices of this invention, combinations of cell elements may be made using a sequence of atmospheric plasma deposition steps. A finished cell (often of five plasma deposited layers) is then suitably packaged, injected with a liquid electrolyte, and further assembled into a desired collection and arrangement of cells for a specified lithium battery. However, this specification focuses on the manufacture of positive and negative electrodes comprising a metal current collector with a plasma-deposited layer of particles of electrode material on at least one face of the current collector.

The electrolyte for the lithium-ion cell is often a lithium salt dissolved in one or more organic liquid solvents. Examples of salts include lithium hexafluorophosphate (LiPF₆), lithium tetrafluoroborate (LiBF₄), lithium perchlorate (LiClO₄), lithium hexafluoroarsenate (LiAsF₆), and lithium trifluoroethanesulfonimide. Some examples of solvents that may be used to dissolve the electrolyte salt include ethylene carbonate (EC), dimethyl carbonate (DMC), methyl ethyl carbonate (EMC), and propylene carbonate (PC). There are other lithium salts that may be used and other solvents. But a combination of lithium salt and liquid solvent is selected for providing suitable mobility and transport of lithium ions in the operation of the cell. The electrolyte is carefully dispersed into and between closely spaced layers of the electrode elements and separator layers. The electrolyte is not illustrated in the FIG. 1 drawing because it is difficult to illustrate the electrolyte between tightly compacted electrode layers.

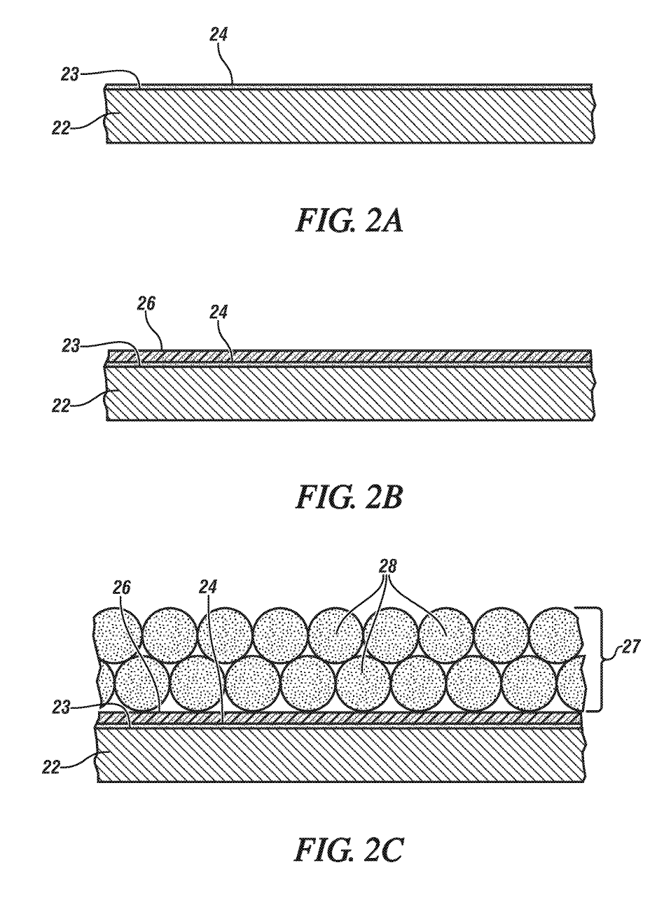

In practices of this invention, the electrode members are formed by use of atmospheric plasma spray devices to deposit particles of electrode material onto one or both surfaces of a compatible metal current collector foil. Examples of suitable particulate materials for positive electrodes include lithium manganese nickel cobalt oxide, lithium manganese oxide, lithium cobalt oxide, lithium nickel aluminum cobalt oxide, lithium iron phosphate, and other lithium oxides and phosphates. Examples of particulate negative electrode materials include lithium titanate, graphite and other forms of carbon, and silicon-based materials such silicon, silicon-based alloys. SiOx, silicon-tin composites, and lithium-silicon alloys. But we have found that the presence of a metal oxide film on the aluminum or copper foil surfaces, or even a stainless steel foil surface, can inhibit the adherence of plasma-sprayed particles of electrode material to the surface of the collector foil. The presence of such a metal oxide layer on a metal current collector foil is depicted in FIG. 2A.

FIG. 2A is an enlarged schematic illustration of a cross-section of a broken out portion of a copper foil current collector 22, which in a plan view or an oblique view might have a rectangular shape, like current collector 12 (illustrated in FIG. 1) and the layer of negative electrode material 14 bonded to a face of current collector 12. In the cross-sectional view of FIG. 2A, the upper surface 23 of copper foil current collector 22 is covered with a thin layer of a copper oxide 24. Actually, each of the six outer surfaces of copper foil current collector 22 may have some coating of copper oxide. But, in this example, it is intended to deposit particles of electrode material only on upper surface 23, and attention is focused on dealing with copper oxide layer 24. In some practices of electrode manufacture for lithium-ion cells, active electrode material may be applied to both major surfaces of a metal foil current collector. In that embodiment, the metal oxide coatings on both surfaces would be covered by a conductive polymer layer in accordance with this invention. Generally, the metal oxide coating, such as copper oxide film 24, is quite thin, e.g., less than about one micrometer in thickness.

The copper oxide layer 24 on at least upper surface 23 of copper foil current collector 22 is covered with a thin layer of a conductive coating 26 in accordance with practices of this invention. In an illustrative example, conductive coating 26 is suitably composed of polyvinylidene difluoride filled with a suitable quantity of nanometer size, conductive carbon particles. Conductive coating layer 26 may be applied, for example, by applying and spreading a solution or a suspension of the polymer and conductive particles over oxide film 24, and then evaporating the liquid solvent or dispersant, to form a coextensive polymer film 26 over at least portions of the current collector surface to which particulate electrode material is to be applied. The conductive coating may be applied over the metal oxide layer 24 by other processes such as by spraying solutions or dispersions of the polymer-particle mixture, or by spraying softened or melted particles or droplets of the filled polymer.

The function of the filled polymer coating is (i) to provide a receptive layer for the deposit of particles of active electrode material using an atmospheric plasma spray device and (ii) to provide a conductive pathway for the flow of electrons between the formed electrode layer and the copper current collector. Typically a suitable negative electrode material would be used in combination with a copper current collector. Suitably, the conductive coating 26 is about one to three micrometers in thickness.

Examples of suitable polymers for use in this process include polyethylene oxide and/or polypropylene oxide and/or polyvinylidene difluoride (PVDF). These are examples of non-conductive polymers which can be filled with particles of an electrically conductive material. The polymer is selected to provide a surface receptive to the particles of active electrode material to be deposited and the conductive particles are selected to enhance electrical conductivity through the polymer layer. For example, the relatively hot, plasma-activated particles first impacting the polymer surface may imbed themselves in the polymer layer, providing intimate contacts between applied electrode particles and the polymer layer. Suitable particles include electrically conductive carbon particles and fine copper or aluminum particles. The polymer is suitably dissolved in a solvent, such as N-methyl-2-pyrrolidone (NMP), and a predetermined quantity of finely-divided conductive particles. The proportions of polymer and conductive particles are determined to provide these properties in conductive coating 26. For example, about one to fifteen parts by weight of conductive carbon particles may be uniformly mixed with ten parts by weight of PVDF dissolved in NMP. A suitable viscous mixture of conductive carbon particles dispersed in the PVDF solution is applied onto the metal oxide surface of the current collector. The solvent is evaporated from the slurry (and recovered) under predetermined conditions to leave a residual coating layer 26 of (in this illustrative example) carbon particles in PVDF on and covering the copper oxide layer 24 on surface 23 of current collector 22. Preferably the carbon particle-filled PVDF conductive layer is about one to three micrometers thick and free of pinholes or the like. As stated, the purpose of protective layer 26 is to isolate metal oxide layer 24 from later-applied electrode material particles while providing a conductive path between the electrode layer (27 in FIG. 2C) and the current collector 22

FIG. 2C is a schematic illustration of a layer 27 of atmospheric plasma deposited negative electrode particles 28 formed on the conductive coating layer 26 of copper current collector foil 22. The illustration of the layer 27 of deposited negative electrode particles 28 is idealized. An example of a suitable negative electrode material is lithium titanate particles. The lithium titanate particles may be mixed or coated with binder material, such as particles of metallic binder. In some practices, a polymeric bonder may be deposited on a layer of plasma deposited electrode particles.

The negative electrode material particles are suspended in a stream of air, nitrogen, or inert gas, subjected to a predetermined atmospheric plasma activation energy and the plasma-activated stream directed against the conductive polymer layer 26 so as to form a coextensive particulate layer 27 of negative electrode particles 28. The particles 28 are not necessarily uniformly arranged as illustrated in FIG. 2C, but the particles do form a porous layer 27 of generally uniform thickness and having porosity suitable for later infiltration with a non-aqueous electrolyte comprising a solution of lithium ions. The size of the electrode particles in FIG. 2C is exaggerated for illustration. The sizes of the plasma deposited particles are typically in the range of about one to ten micrometers, comparable to the thickness of the conductive polymer layer, and the total thickness of the deposited layer of negative electrode particles is about twenty-five to about two hundred micrometers.

As stated, the layer of electrode material particles is deposited on a compatible, conductive layer-coated, current collector using one or more atmospheric plasma nozzles or deposition devices. Such plasma nozzles for this application are commercially available and may be carried and used on robot arms, under multi-directional computer control, to apply suitable electrode particles to coat the surfaces of each conducive layer coated, metal current collector foil for a lithium-ion cell module. Multiple nozzles may be required and arranged in such a way that a high coating speed may be achieved in terms coated area per unit of time.

The plasma nozzle typically has a metallic tubular housing which provides a flow path of suitable length for receiving the flow of working gas and dispersed particles of electrode material (or of metal binder/conductor particles) and for enabling the formation of the plasma stream in an electromagnetic field established within the flow path of the tubular housing. The tubular housing terminates in a conically tapered outlet, shaped to direct the shaped plasma stream toward an intended substrate to be coated. An electrically insulating ceramic tube is typically inserted at the inlet of the tubular housing such that it extends along a portion of the flow passage. A stream of a working gas, such as air (or nitrogen or argon), and carrying dispersed particles of metal particle-coated electrode material, is introduced into the inlet of the nozzle. The flow of the air-particle mixture may be caused to swirl turbulently in its flow path by use of a swirl piece with flow openings, also inserted near the inlet end of the nozzle. A linear (pin-like) electrode is placed at the ceramic tube site, along the flow axis of the nozzle at the upstream end of the flow tube. During plasma generation the electrode is powered by a suitable generator at a frequency in the 0.1 hertz to gigahertz range and to a suitable potential of a few kilovolts. Plasma generation technology such as corona discharge, radio wave, and microwave sources, and the like, may be employed. The metallic housing of the plasma nozzle is grounded. Thus, an electrical discharge can be generated between the axial pin electrode and the housing. No vacuum chamber is used.

When the generator voltage is applied, the frequency of the applied voltage and the dielectric properties of the ceramic tube produce a corona discharge at the stream inlet and the electrode. As a result of the corona discharge, an arc discharge from the electrode tip to the housing is formed. This arc discharge is carried by the turbulent flow of the air/particulate electrode material stream to the outlet of the nozzle. A reactive plasma of the air and electrode material mixture is formed at a relatively low temperature. A copper nozzle at the outlet of the plasma container is shaped to direct the plasma stream in a suitably confined path against the surfaces of the substrates for the lithium-ion cell elements. The energy of the plasma may be determined and managed for the material to be applied.

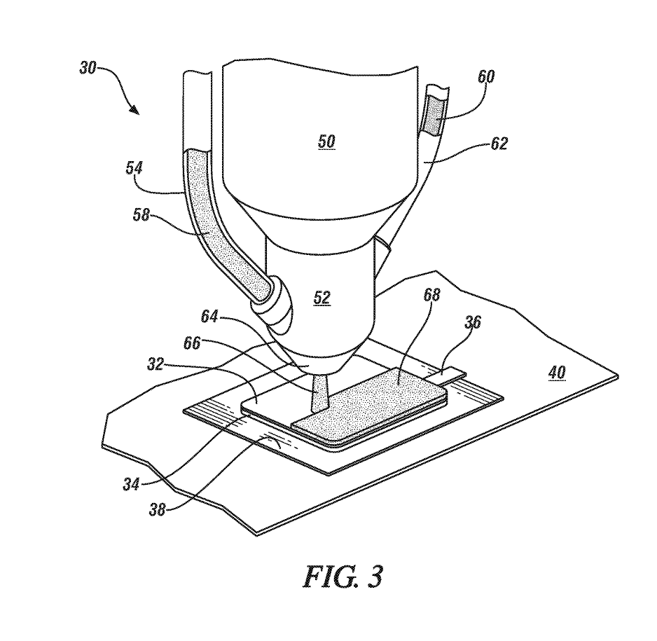

FIG. 3 illustrates the practice of using an atmospheric plasma application device 30, with two particle feeds, to deposit active electrode material particles on a surface of a metal current collector foil. The current collector foil has been previously coated with a conductive polymer layer covering a metal oxide film on the surface to which the electrode material particles are to be applied. In this illustrative example, the substrate is the conductive polymer layer 32, previously formed on the surface of a copper current collector foil 34. As described above in this specification, the conductive polymer layer contains electrically conductive particles which are not illustrated in this figure. The copper oxide film, inherently present on copper foil 34, is not illustrated in this drawing figure. The current collector foil may have a connection tab 36 for connection of a finished electrode to other electrodes in a lithium-ion cell or module of cells. But the connection tab 36 is not coated with the electrode material or with the conductive polymer layer.

In this example, the current collector foil 34, with its conductive coating 32 is carried on a substrate 38, which may be a resin-coated steel foil sized and shaped to serve as a pouch or enclosure material for a finished cell member. Substrate 38 in turn may be carried on a conveyor belt 40, or the like, for locating the current collector foil 34, with its conductive coating layer 32 under the plasma application device 30 for deposition of particulate electrode material on the surface of the conductive polymer layer 32. This process may be conducted in air and in a normal ambient workplace atmosphere.

In this example, the current collector foil 34 and conductive coating layer 32 are illustrated in the form of a thin, square layers of about 100 millimeters length on each side, but the cell elements are also often made in other rectangular shapes and dimensions depending on the intended size of the cell elements and assembled cell modules. The copper current collector layer 34 is often about ten to twelve micrometers in thickness and the conductive coating 32 is thinner. The substrate 38 is moved and placed in a flat position at ambient conditions under a suitable atmospheric plasma spray generator apparatus 30 with a nozzle for directing a plasma stream. The nozzle and/or workpiece may be carried on a suitable support and moved under suitable programmable controls for sequential deposition of particulate electrode material on the conductive surface layer 32.

In practices of this invention, and with reference to FIG. 3, an atmospheric plasma apparatus may comprise an upstream round flow chamber 50 (shown partly broken-off in FIG. 3) for the introduction and conduct of a flowing stream of suitable working gas, such as air, nitrogen, or an inert gas such as helium or argon. The flow of the working gas would be introduced above the broken-off illustration of flow chamber 50 and proceed in a downward direction. In this embodiment, this illustrative initial flow chamber 50 is tapered inwardly to smaller round flow chamber 52. Active electrode material particles (for example, lithium titanate particles) 58 are delivered through opposing supply tubes 54, 62 into round flow chamber 52. Supply tubes 54, 62 are shown partially broken-away to illustrate delivery of the electrode material particles 58, 60. The electrode material particles suitably introduced from opposing sides of the apparatus into the working gas stream in chamber 52 and then carried into a plasma nozzle 64 in which the air (or other working gas) is converted to a plasma stream at atmospheric pressure. As the electrode material particles enter the gas stream in chamber 52 they are dispersed and mixed in the stream and carried by it. As the stream flows through the downstream plasma-generator nozzle 64, the electrode material particles are heated by the formed plasma of predetermined and controlled energy to a precursor processing temperature. The momentary thermal impact on the electrode material particles may be a temperature of from about 300° C. up to about 3500° C. The plasma activated electrode material particles exit nozzle 64 as stream 66.

In this example, the stream 66 of air-based plasma and suspended, plasma-activated, electrode material particles (for example, graphite particles or lithium titanate particles) is progressively directed by the nozzle 60 to deposit electrode material 68 against the surface of the conductive polymer layer 32 on the copper foil current collector 34. The nozzle 64 and stream 66 of suspended electrode material is moved in a suitable path and at a suitable rate such that the particulate electrode material 68 is deposited as a layer of electrode particles 68 of specified thickness on the conductive polymer surface 32 of the current collector foil 34. The electrode material particles 68 are ultimately bonded to each other and to the conductive polymer surface 32 of current collector foil 34.

Depending on the physical characteristics of the particles of electrode material it may be desirable to provide a binding agent to bond the particles to each other and to the conductive layer on the current collector. The electrode particles may, for example, be coated with particles of a metal that will melt in the plasma generator and bond the electrode particles as they are deposited. Or particles of a suitable polymer binder may be separately deposited and mixed with the electrode particles as the electrode particles are being deposited from the plasma device.

The substrate 38, with its newly formed electrode member (consisting of current collector layer 34 and electrode material layer 68), may then be moved to a further processing location. The electrode member may be combined with a separator and an opposing electrode member in the making or assembly of a lithium-ion cell.

Such plasma nozzles 30 for this application are commercially available and may be carried and used on robot arms, under multi-directional computer control, to coat the surfaces of each planar substrate for a lithium-ion cell module. Multiple nozzles may be required and arranged in such a way that a high coating speed may be achieved in terms coated area per unit of time.

The thin, micrometer-thick, conductive polymer coating used in the illustration depicted in FIGS. 2A-2C, for covering the copper oxide layer on the current collector, consisted of a non-conductive polymer, PVDF, filled with electrically conductive particles, specifically, conductive carbon particles. However, the conductive polymer coating may also be formed using conductive polymer compositions.

For example, a thin conductive coating may be formed of a non-conductive polymer matrix material filled with small particles (powder) of a conductive polymer. In this example, non-conductive polymers such as PVDF, polyethylene oxide (PEO), and polypropylene oxide (PPO) may be used as the matrix polymer material. And the conductive polymer powder is used for the purpose of imparting electric conductivity to the polymer layer in the metal oxide film. The non-conductive polymer is dissolved in a solvent such as NMP and particles of the conductive polymer, with particle sizes in the nanometer range up to about one micrometer, are suspended in the solvent. The slurry of conductive polymer particles (dispersed in the solution of non-conductive polymer) is, for example, brushed, rolled or sprayed onto the metal oxide surface, and the solvent evaporated under suitable processing conditions to leave the non-porous, micrometer thick, coating covering the oxide surface of the current collector.

Examples of suitable conductive polymers include polythiophene (PT), poly(3-methyl thiophene) [P(3MeT)], poly(3,4-ethylenedioxythiophene) (PEDOT), polyaniline (PANI), polypyrrole (PPy), polycarbazole, polyindoles, polyazepine, poly(para-phenylene) (PPP), polyacene, poly(fluorine), polypyrene, polyazulene, polynaphthalene, and poly(para-phenylene vinylene) (PPV). These conductive polymer compositions are commercially available and in fine powder form. And most of these electrically conductive polymers are not readily dissolved in common solvents. Their powders may be suspended for coating in a solution of one of the above identified non-conductive polymers.

In another example, the conductive polymer coating may be prepared from an electrically conductive polymer that serves to bond to the metal oxide surface and to conduct electrons from an electrode material to the metal oxide layer. Examples of such electrically conductive polymers that can serve as both a binder and a conductive medium include block copolymers of PVDF or PEO or PPO and one of the following polymers: PT, P(3MeT), PEDOT, PANI, PPy, polycarbazole, polyindoles, polyazepine, PPP, polyacene, poly(fluorine), polypyrene, polyazulene, polynaphthalene, and PPV. Some samples of such block copolymers are PVDF-b-PT, PVDF-b-P(3MeT), PVDF-b-PEDOT, PEO-b-PT, PEO-b-P(3MeT), PEO-b-PEDOT, PPO-b-PT, PPO-b-P(3MeT), and PPO-b-PEDOT (where -b- designates a block copolymer).

A slurry or solution of any of these electrically conductive, block-copolymers may be applied to the metal oxide surface of a current collector by spraying or other coating process using a suitably viscous layer to adhere to the metal oxide surface. The applied coating is then dried to form the micrometer-thick conductive polymer layer over the metal oxide surface. In many of these block copolymers, the block component of PVDF or PEO or PPO increases the solubility of the conductive constituent of the block polymer (for example PT, P(3MeT), or PEDOT. So the resulting block co-polymer may be completely soluble or partially soluble in a solvent, such as NMP.

Another type of suitable electrically conductive polymers is polymers with a conductive polymer as the polymer backbone/main-chain and one of PVDF, PEO, or PPO as the side chain constituent. One of PVDF, PEO, or PPO can be attached to conductive polymer to serve as the side chain constituent via a spacer such as an alkyl chain, or with no spacer moiety. Some examples are P(T-PVDF), P(T-PEO), P(T-PPO), P(3MeT-PVDF), P(3MeT-PEO), and P(3MeT-PPO).

Some structural formula examples follow:

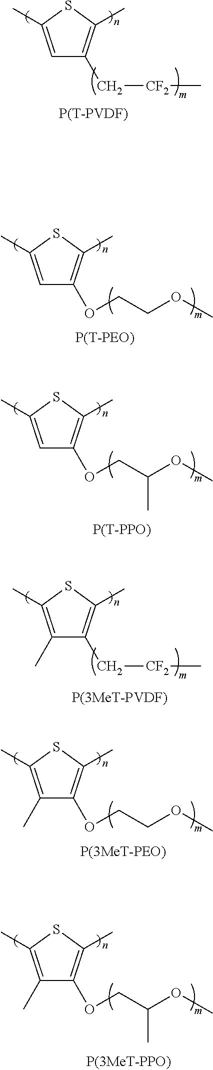

Slurries or solutions of these electrically conductive copolymers may be applied to the metal oxide surface of a current collector and dried to form a micrometer (or so) thick layer of the conductive polymer.

In a different practice, the conductive co-polymer may be formed on the metal oxide surface by electro-deposition of a monomer of the conductive polymer moiety containing a pendent group of PVDF or PEO or PPO as illustrated in the following reaction.

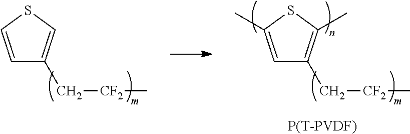

Electrochemical deposition is also called electropolymerization. Since the metallic current collector is electrically conductive, it can be used as a substrate for electropolymerization. To enhance electrical conductivity, a monomer such as thiophene, pyrrole, and carbazole can be added to copolymerize with a thiophene derivative with a pendant PVDF. The resulting polymer P(T-PVDF-T) is a random copolymer, not a block polymer.

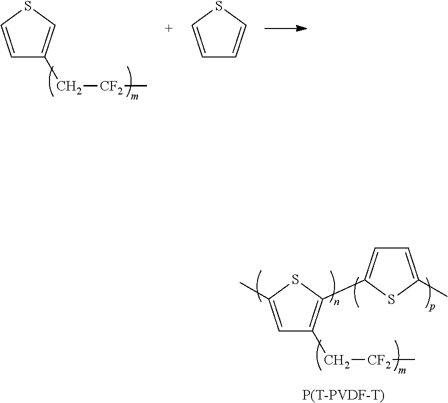

Thus, a variety of practices and polymer compositions have been disclosed for forming a relatively thin (e.g., about one to three micrometers thick) uniform conductive layer of a polymer on the surface of a metal current collector foil having a surface film of metal oxide. The conductive polymer layer serves as a compatible surface for the deposit of a porous layer of plasma heated particles of an electrode material for a lithium-ion battery cell. And the conductive polymer layer provides a suitably conductive path between the current collector and the layer of electrode material.

While practices of the invention have been described using specific illustrations, the scope of the invention is not limited by these illustrations.

1. A method of making an electrode for a lithium-ion cell using an atmospheric plasma to deposit a layer of particles of active electrode material on a surface of a metal current collector foil when the surface of the metal current collector foil has an integral film of an oxide of the metal, the method comprising:
applying a layer of an electrically conducive polymer composition on the film of metal oxide over the surface area of the metal current collector foil to which the particles of active electrode material are to be applied, the thickness of the layer of polymer composition no greater than about three micrometers and the electrically conductivity of the polymer layer composition providing electron conductivity between the current collector foil and the active electrode material to be deposited;
forming an atmospheric plasma-activated, gas-borne stream of particles of the active electrode material and depositing the particles from the stream onto the electrically conductive particle-filled polymer layer to form a layer of the electrode material particles on the electrically conductive polymer layer.

2. A method of making an electrode for a lithium-ion cell as stated in claim 1 in which the deposited electrically conductive polymer composition comprises a non-conductive carbon-based polymer filled with electrically conductive particles, the content of electrically conductive particles in the polymer layer providing electron conductivity between the current collector foil and the active electrode material to be deposited.

3. A method of making an electrode for a lithium-ion cell as stated in claim 2 in which the non-conductive carbon-based polymer comprises one or more of polyvinylidene difluoride, polyethylene oxide, and polypropylene oxide.

4. A method of making an electrode for a lithium-ion cell as stated in claim 2 in which the electrically-conductive particles comprise at least one of carbon particles, copper particles, and aluminum particles, the electrically conductive particles having a particle size no greater than one micrometer.

5. A method of making an electrode for a lithium-ion cell as stated in claim 2 in which the electrically conducive particle-filled, carbon-based polymer layer contains nine to sixty percent by weight of electrically conductive particles.

6. A method of making an electrode for a lithium-ion cell as stated in claim 4 in which the electrically conducive particle-filled, carbon-based polymer layer contains nine to sixty percent by weight of electrically conductive particles.

7. A method of making an electrode for a lithium-ion cell as stated in claim 2 in which the electrically conductive particles are particles of an electrically conductive organic polymer, the electrically conductive particles having a particle size no greater than one micrometer.

8. A method of making an electrode for a lithium-ion cell as stated in claim 1 in which the deposited electrically conductive polymer composition comprises an electrically conductive polymer providing electron conductivity between the current collector foil and the active electrode material to be deposited.

9. A method of making an electrode for a lithium-ion cell as stated in claim 1 in which the deposited electrically conductive polymer composition comprises an electrically conductive polymer providing electron conductivity between the current collector foil and the active electrode material to be deposited, the electrically conductive polymer composition comprising a copolymer having conductive polymer segments and non-conductive polymer segments.

10. A method of making an electrode for a lithium-ion cell as stated in claim 1 in which the current collector foil is formed of one of the metals selected from the group consisting of copper, aluminum, and stainless steel.

11. A method of making an electrode for a lithium-ion cell as stated in claim 1 in which the particles of electrode material are mixed with a binder material by the time that they are deposited from the gas-borne atmospheric plasma-activated spray stream as a porous layer of electrode material particles on the electrically conducive polymer composition, the binder bonding the electrode material particles to each other in a porous electrode material layer to the polymer coating on the surface of the current collector surface.

12. A method of making an electrode for a lithium-ion cell as stated in claim 1 in which a binder material is applied to the electrode particles after they have been deposited as a layer of electrode particles on the conductive polymer layer, the binder bonding the electrode material particles to each other in a porous electrode material layer to the polymer coating on the surface of the current collector surface.

13. A method of making an electrode for a lithium-ion cell as stated in claim 1 in which particles of negative electrode material are deposited on the electrically conductive polymer composition.

14. A method of making an electrode for a lithium-ion cell as stated in claim 1 in which particles of positive electrode material are deposited on the electrically conductive polymer composition.

15. A method of making an electrode for a lithium-ion cell using an atmospheric plasma to deposit a layer of particles of active electrode material on a surface of a metal current collector foil when the surface of the metal current collector foil has an integral film of an oxide of the metal, the film of the oxide being less than about one micrometer in thickness, the method comprising:
applying a layer of an electrically conducive polymer composition on the film of metal oxide over the surface area of the metal current collector foil to which the particles of active electrode material are to be applied, the thickness of the layer of polymer composition being no greater than about three micrometers and the electrically conductivity of the polymer layer composition providing electron conductivity between the current collector foil and the active electrode material to be deposited;
forming an atmospheric plasma-activated, gas-borne stream of particles of the active electrode material and depositing the particles from the stream onto the electrically conductive particle-filled polymer layer to form a porous layer of the electrode material particles on the polymer layer; and then
applying a binder material to the porous layer of electrode material particles to bond the electrode material particles to each other as an integral porous layer of electrode material particles and to bond the electrode layer to the polymer surface, the thickness of the bonded integral porous electrode layer being up to about two hundred micrometers.

16. A method of making an electrode for a lithium-ion cell as stated in claim 15 in which the deposited electrically conductive polymer composition comprises a non-conductive carbon-based polymer filled with electrically conductive particles, the content of electrically conductive particles in the polymer layer providing electron conductivity between the current collector foil and the active electrode material to be deposited.

17. A method of making an electrode for a lithium-ion cell as stated in claim 16 in which the non-conductive carbon-based polymer comprises one or more of polyvinylidene difluoride, polyethylene oxide, and polypropylene oxide.

18. A method of making an electrode for a lithium-ion cell as stated in claim 16 in which the electrically-conductive particles comprise at least one of carbon particles, copper particles, aluminum particles, and particles of an electrically conductive polymer, the electrically conductive particles having a particle size no greater than one micrometer.

19. A method of making an electrode for a lithium-ion cell as stated in claim 18 in which the electrically conducive particle-filled, carbon-based polymer layer contains nine to sixty percent by weight of electrically conductive particles.

20. A method of making an electrode for a lithium-ion cell as stated in claim 15 in which the deposited electrically conductive polymer composition comprises an electrically conductive polymer providing electron conductivity between the current collector foil and the active electrode material to be deposited, the electrically conductive polymer composition comprising a copolymer having conductive polymer segments and non-conductive polymer segments.
